(19) United States
(12) Patent Application Publication
(10) Pub. No.: US 2008/0003507 A1
(43) Pub. Date: Jan. 3, 2008

(54) Formulation Of Electrolyte Solutions For Electrochemical Chlorine Dioxide Generators

(76) Inventor: Chenniah Nanjundiah, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/751,369

(22) Filed: May 21, 2007

Related U.S. Application Data
(60) Provisional application No. 60/806,380, filed on Jun. 30, 2006.

(51) Int. Cl. H01G 9/035

(52) U.S. Cl. 429/326; 252/62.2

(57) ABSTRACT

The current disclosure relates to a feed solution for an electrochemical generator, the feed solution comprising at least one of a chlorite solution and/or a chlorate solution, wherein hardness-causing ion concentration in at least one of the chlorite solution and/or the chlorate solution is reduced to less than 1 part per million using at least one of an ion exchange method and/or a precipitation method. The current disclosure additionally relates to an electrochemical chlorine dioxide generator wherein the reactant feedstock is an electrolyte solution passed through an ion exchange column, the ion exchange column capable of substantially removing hardness-causing ions in the electrolyte solution. The current disclosure further relates to a method for assessing acceptable concentrations of hardness-causing impurities in an electrolyte solution. Additionally, the current disclosure relates to methods for reducing impurities in a sodium chlorite reactant feedstock.

### CROSS-REFERENCE TO RELATED APPLICATION(S)

This application relates to and claims priority benefits from U.S. Provisional Patent Application Ser. No. 60/806,380, filed Jun. 30, 2006, entitled “Formulation of Electrolyte Solutions for Electrochemical Chlorine Dioxide Generators.” The '380 provisional application is hereby incorporated herein in its entirety.

### FIELD OF THE INVENTION

The present invention relates generally to electrolyte solutions for electrochemical generators. More particularly, the present invention relates to formulations and methods for hardness control of electrolyte solutions used in electrochemical chlorine dioxide generators. This makes it possible to achieve higher efficiencies at electrodes.

### BACKGROUND OF THE INVENTION

Chlorine dioxide (ClO₂) has many industrial and municipal uses. When produced and handled properly, ClO₂ is an effective and powerful biocide, disinfectant and oxidizer.

ClO₂ is used extensively in the pulp and paper industry as a bleaching agent, but is gaining further support in such areas as disinfection in municipal water treatment. Other end-uses can include as a disinfectant in the food and beverage industries, wastewater treatment, industrial water treatment, cleaning and disinfections of medical wastes, textile bleaching, odor control for the rendering industry, circuit board cleansing in the electronics industry and uses in the oil and gas industries.

In water treatment applications, ClO₂ is primarily used as a disinfectant for surface waters with odor and taste problems. It is an effective biocide at low concentrations and over a wide pH range. ClO₂ is desirable because when it reacts with an organism in water, chlorite results, which studies to date have shown does not pose a significant adverse risk to human health at chlorite concentrations less than 0.8 parts per million (ppm). The use of chlorine, on the other hand, can result in the creation of chlorinated organic compounds when treating water. Such chlorinated organic compounds are suspected to increase cancer risk.

Producing ClO₂ gas for use in a ClO₂ water treatment process is desirable because there is greater assurance of ClO₂ purity when ClO₂ is in the gas phase. ClO₂ is, however, unstable in the gas phase and will readily undergo decomposition into chlorine gas (Cl₂), oxygen gas (O₂) and heat. The high reactivity of ClO₂ generally requires that it be produced and used at the same location. ClO₂ is soluble and stable in an aqueous solution.

The production of ClO₂ can be accomplished both by electrochemical and reactor-based chemical methods. Electrochemical methods have an advantage of relatively safer operation compared to reactor-based chemical methods. In this regard, electrochemical methods employ a single precursor chemical, such as, a chlorite solution, unlike the multiple precursor chemicals employed in reactor-based chemical methods. Moreover, in reactor-based chemical methods, the use of concentrated acids and chlorine gas can pose safety concerns.

Electrochemical cells are capable of carrying out a selective oxidation reaction of chlorite to ClO₂. The selective oxidation reaction product is a solution containing ClO₂. To further purify a ClO₂ gas stream obtained from the selective oxidation reaction, the gas stream is typically separated from the solution using a stripper column. In the stripper column, air is passed from the bottom of the column to the top while the ClO₂ solution travels from top to the bottom. Substantially pure ClO₂ is exchanged from solution to the air. Suction of air is usually accomplished using an eductor, as described in copending and co-owned application Ser. No. 10/902,681, which is incorporated herein by reference.

As described in the '681 application, ClO₂ can be prepared a number of ways, generally via a reaction involving either chlorite (ClO₂⁻) or chlorate (ClO₃⁻) solutions. The ClO₂ created through such a reaction is often refined to generate ClO₂ gas for use in the water treatment process. The ClO₂ gas is then educted into the water selected for treatment. Eduction occurs where the ClO₂ gas, in combination with air, is mixed with the water selected for treatment.

Electrochemical generation of ClO₂ is desirable in applications where a substantially pure ClO₂ is preferred such as in the food, beverage and pharmaceutical industries and for cleaning reverse osmosis membranes. An electrochemical cell typically has a membrane to separate the anolyte and the catholyte in the electrochemical reaction. Examples of membrane materials used in electrochemical cells are the Nafion® product from Du Pont and the Flemion® product from Asahi Glass. The Nafion® and Flemion® products are flouro polymers with a sulfonic acid group (SO₃H) and carboxylic acid (COOH) group respectively. Nafion®—and Flemion®—based and comparable membranes preferentially allow cations, such as a sodium ion (Na⁺), to be exchanged for the hydrogen ion (H⁺) of the SO₃H and COOH groups. In addition, these membranes also prevent the migration of OH from the cathode side of the electrochemical cell. Composite membranes having an anode side made of Nafion and a cathode side made of Flemion leak less hydroxide ions compared to single membranes. In the example of a sodium chlorite (NaClO₂) solution fed into an anode compartment of the electrochemical cell, the NaClO₂ oxidizes into ClO₂ as shown in the following equation:

NaClO₂→ClO₂+Na⁺+e⁻

In the cathode compartment of the electrochemical cell, water (H₂O) is reduced which results in the formation of hydrogen gas (H₂) and hydroxide (OH⁻) as demonstrated by the following equation:

H₂O+e⁻→½H₂+OH⁻

The net reaction is:

NaClO₂+H₂O→ClO₂+NaOH+½H₂

During the reaction of NaClO₂ in electrochemical cells using, for example, a Nafion® membrane, sodium ions cross the membrane separating the anode and cathode compartments of the cell and results in the formation of sodium hydroxide (NaOH) in the cathode compartment.

An electrochemical cell can have some ion leakage in the membrane that separates the anode and cathode compartments. Such leakage can result in impurities from the anolyte being transported through the membrane. For instance, with a NaClO₂ solution, some divalent and trivalent ions present in the anolyte, such as Mg²⁺, Ca²⁺ and Al³⁺, can be transported through the membrane into the cathode and form hydroxides of the divalent and trivalent cations, such as Mg(OH)₂, Ca(OH)₂, and Al(OH)₃. Unlike the NaOH that results in the cathode compartment, the divalent and trivalent hydroxides resulting from the impurities precipitate inside and outside the membrane, sometimes referred to as fouling the membrane. The precipitation on the membrane of the electrochemical cell occurs because the solubility of the divalent and trivalent hydroxides is very low (see Table 1) compared to NaOH.

TABLE 1
Solubility Product and Solubility of Selected Ions at 25° C.

| | | | Solubility of |
|---|---|---|---|
| | Solubility | Solubility | Cations |
| Compound | Product Constant | (weight %) | (ppb) |
| NaOH | Highly soluble | 54 | Highly soluble |
| Ca(OH)₂ | 7.88 × 10⁻⁶ | 5.00 × 10⁻² | 500000 |
| Mg(OH)₂ | 5.66 × 10⁻¹² | 2.75 × 10⁻⁴ | 2750 |
| Ni(OH)₂ | 5.54 × 10⁻¹⁶ | 3.10 × 10⁻⁵ | 304 |
| Fe(OH)₂ | 4.80 × 10⁻¹⁷ | 9.20 × 10⁻⁶ | 92 |
| Al(OH)₃ | 1.30 × 10⁻³³ | 2.63 × 10⁻⁹ | 0.07 |
| Ca₃(PO₄)₂ | 2.02 × 10⁻³³ | 5.60 × 10⁻⁷ | 5.6 |

Ions with a lower solubility, such as Mg²⁺, Ca²⁺ and Al³⁺, are sometimes described as hardness-causing ions since they can form hard scales at the membrane. Table 1 shows the solubility for select hydroxide and phosphate compounds in neutral water, that is water at pH 7, obtained from the Handbook of Chemistry and Physics (CRC Press, 64th edition). In accordance with the common ion effect, if the concentration of hydroxide increases, the solubility of the cation will decrease in order to keep the solubility product constant, sometimes causing the cation to precipitate out of the solution.

The common ion effect can lead to performance issues in membranes of electrochemical cells. For instance, the pH of an anolyte in an electrochemical cell can be between 5.5 and 6, and at this pH, the solubility of cations (for example, Mg²⁺, Ca²⁺, Fe²⁺ and Ni²⁺) is slightly higher than the values shown above in Table 1. As the cations approach and cross the membrane into the cathode, the pH of the electrolyte increases due to an increase in the hydroxide concentration, which can range from 5 to 10 M. The increase in pH decreases the solubility of the multivalent ions and results in the ions precipitating in their hydroxide form.

The precipitation of the multivalent ions in their hydroxide form fractures the polymeric backbone of the membrane. This creates micro-cracks on the membrane. Damage in the membrane leads to mixing of anolyte and catholyte, which leads to a decrease in cell efficiency. For example, the sodium hydroxide formed in the cathode compartment migrates to the anode side and reacts with chlorine dioxide as follows:

2NaOH+2ClO₂→NaClO₂+NaClO₃

### Due to this side reaction, chlorine dioxide yield is much lower than 100%.

Over time migration of hydroxide to the anolyte compartment causes the efficiency of the electrochemical cells to decrease to the point that the cells have to be changed. Thus, the hardness-causing ions in the anolyte lead to increased operation costs for chlorine dioxide generation systems using electrochemical cells.

FIG. 1 shows an example of different impurities that can lead to failure of a Nafion® membrane in a chlorine dioxide electrochemical cell. FIG. 1 is a plot 100 of various impurities found in a membrane obtained using an electron dispersion x-ray spectrum (EDX). The data plotted in FIG. 1 was obtained from an electrochemical cell that was fed with a commercial-grade NaClO₂ electrolyte solution that contained multivalent ion impurities such as Mg²⁺, Ca²⁺, Fe²⁺, Ni²⁺ and Al³⁺. The impurities show up as localized peaks in the EDX plot 100. The EDX plot 100 further shows the presence of non-metals such as Si, P, 0, C, Cl and F. The precipitation in Nafion® membranes of hydroxides of alkaline earth metals, including Ca, Mg, Ba and Sr, has also been reported in the electrochemistry literature for sodium chloride anolytes (see Y. Ogata et al., “Effects of the Brine Impurities on the Performance of the Membrane-Type Chlor-Alkali Cell,” Journal of the Electrochemical Society, vol. 136, no. 1, January 1989, p. 91). The precipitation of Si as Ca₂SiO₄H₂O has further been reported in other electrochemistry literature (see F. Hine, “Effect of Silicate on the Membrane-Type Chlor-Alkali Cell,” Journal of Applied Electrochemistry, 21 (1991) 781-84).

Commercial-grade NaClO₂ solutions can have Ca²⁺ concentrations in the range of 0.5 parts per million (ppm) to 40 ppm and Mg²⁺ concentrations in the range of 10 parts per billion (ppb) to 300 ppb. The concentrations of Ca²⁺ and Mg²⁺ in commercial-grade NaClO₂ solutions are lower than the cation solubility reported in Table 1 in neutral water. The reason for the lower concentration of Ca²⁺ and Mg²⁺ impurities is because the alkalinity of the NaClO₂ solution will cause the impurities to precipitate. The resulting precipitate can be filtered prior to feeding the solution into the electrochemical cell.

Even after filtering of the NaClO₂ solution, the presence of hardness-causing ions in the parts per million and parts per billion ranges can be enough to lead to a failure of the electrochemical cell membrane. It is therefore desirable for a method of assessing the functional amount of impurities that are acceptable in the operation of electrochemical cells that decreases membrane replacement costs. It is further desirable to formulate and assess acceptable anolyte solution compositions that decrease membrane replacement cost. It is further desirable to develop methods to maintain higher cell efficiency at various currents.

### SUMMARY OF THE INVENTION

In one embodiment, the current feed solution for an electrochemical generator is made up of at least one of a chlorite solution and a chlorate solution, wherein hardness-causing ion concentration in at least one of the chlorite solution and the chlorate solution is reduced to less than 1 part per million using at least one of an ion exchange method and a precipitation method.

In other embodiments, the hardness-causing ion concentration in the chlorite solution can be reduced to less than 50 parts per billion or less than 20 parts per billion.

In one embodiment, the current electrochemical chlorine dioxide generator is made up of (a) an anolyte loop, the anolyte loop comprising a reactant feedstock fluidly connected to an electrochemical cell; and (b) a catholyte loop, the catholyte loop fluidly connected to the electrochemical cell; wherein the reactant feedstock is an electrolyte solution passed through an ion exchange column, the ion exchange column capable of substantially removing hardness-causing ions in the electrolyte solution.

In some embodiments of the chlorine dioxide generator, the hardness-causing ions are calcium ions and they are reduced in the electrolyte solution to less than 1 part per million, less than 50 parts per billion or less than 20 parts per billion.

In some embodiments, the electrochemical chlorine dioxide also includes an eductor, wherein the eductor is fluidly connected to the anolyte loop and the eductor combines chlorine dioxide gas from the anolyte loop with process water.

In some embodiments, the electrochemical chlorine dioxide also includes an absorption loop wherein the absorption loop is fluidly connected to the anolyte loop and the absorption loop processes chlorine dioxide gas from the anolyte loop into a chlorine dioxide solution.

In some embodiments, the electrochemical chlorine dioxide also includes an anode. Possible anode materials include platinum or a noble metal oxide such as iridium oxide, ruthenium oxide, palladium oxide. Other mixed metal oxides like iridium and tantalum oxide can also be used.

In some embodiments, the electrochemical chlorine dioxide also includes an ion exchange membrane having an anode side and a cathode side where the cathode side is coated with a polymeric coating containing anionic groups such as carboxylate (COO⁻) groups.

An embodiment of the current method for assessing acceptable concentrations of hardness-causing impurities in an electrolyte solution is made up of the steps of: (a) feeding an electrolyte solution with a known concentration of a target impurity into an anode compartment of an electrochemical chlorine dioxide generator; (b) operating the electrochemical chlorine dioxide generator with the electrolyte solution until a time to degradation (TTD) is reached for a membrane of an electrochemical cell in the electrochemical chlorine dioxide generator; (c) repeating steps (a) and (b) at least once at a different known impurity concentration; (d) creating a plot of the time to degradation vs. impurity concentration; and (e) extrapolating the plot for a desired time to degradation to determine an acceptable concentration of the target impurity.

An embodiment of the current method for reducing impurities in a sodium chlorite reactant feedstock is made up of the steps of: (a) dissolving a sodium chlorite salt into an aqueous solution; (b) passing the aqueous solution with dissolved sodium chlorite salt through at least one ion exchange column; and (c) feeding the aqueous solution into the anode compartment of an electrochemical cell of a chlorine dioxide generator. In some embodiments of this method of reducing impurities acid is added to the purified solution to adjust the pH to less than 10. The pH can also be reduced by bubbling gaseous carbon dioxide.

An embodiment of the current method for reducing calcium impurities in a reactant feedstock is made up of the steps of: (a) dissolving alkaline phosphate into the reactant feedstock solution containing calcium ions, wherein phosphate from the alkaline phosphate will react with the calcium to form calcium phosphate; (b) filtering the resulting calcium phosphate from the reactant feedstock solution; and (c) feeding the filtered reactant feedstock into the anode compartment of an electrochemical cell of a chlorine dioxide generator. In one embodiment of this method of reducing calcium impurities the alkaline phosphate is sodium hydrogen phosphate.

### BRIEF DESCRIPTION OF THE DRAWINGS

FIG. 1 is a plot of various impurities found in an electrochemical cell membrane obtained using an electron dispersion x-ray spectrum.

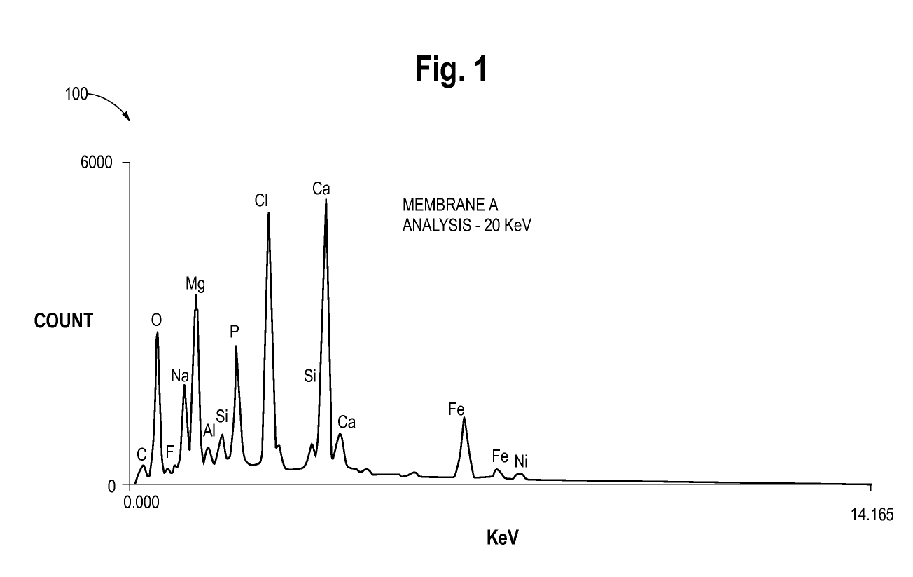

FIG. 2 is a process flow diagram of an electrochemical ClO₂ generator of the type described in application Ser. No. 10/902,681 with hardness control of the reactant feedstock.

FIG. 3 is a process flow diagram of an electrochemical ClO₂ generator with an eductor and hardness control of the reactant feedstock.

FIG. 4 is a graph showing cell voltage and pH as a function of electrolysis time of a 25% sodium chlorite electrolyte that was passed through an ion exchange column to remove hardness ions at a current of 100 ampere (A).

FIG. 5 is a graph showing the efficiency (%) of chlorine dioxide production at various pH levels of a 25% sodium chlorite solution at a Pt rotating ring disk electrode.

### DETAILED DESCRIPTION OF PREFERRED EMBODIMENT(S)

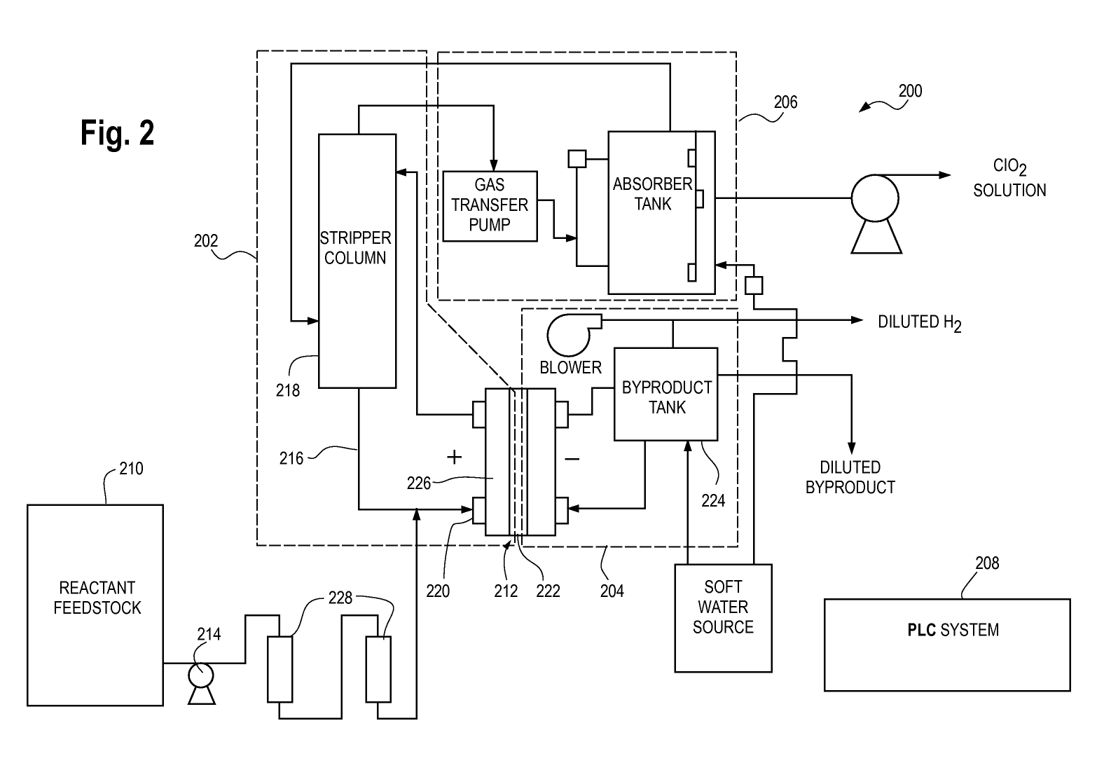

FIG. 2 illustrates a process flow diagram of an embodiment of a chlorine dioxide generator 200 of the type described in application Ser. No. 10/902,681 with hardness control of the reactant feedstock. The process flow of FIG. 2 can comprise three sub-processes including an anolyte loop 202, a catholyte loop 204 and an absorption loop 206. The purpose of anolyte loop 202 is to produce a ClO₂ gas by oxidation of, for example, chlorite, and the process can, along with the catholyte loop process 204, be referred to as a ClO₂ gas generator loop. The ClO₂ gas generator loop is essentially a ClO₂ gas source. Various sources of ClO₂ are available and known in the water treatment field. Catholyte loop 204 of the ClO₂ gas generator loop produces sodium hydroxide and hydrogen gas by reduction of water.

Once the ClO₂ gas is produced in the ClO₂ gas generator loop, the ClO₂ gas can be transferred to, for example, an absorption loop 206 where the gas can be further conditioned for water treatment end-uses. In this application, the term “absorption” refers to the process of dissolving or infusing a gaseous constituent into a liquid, optionally using pressure to effect the dissolution or infusion. Here, ClO₂ gas, which is produced in the ClO₂ gas generator loop, can be “absorbed” (that is, dissolved or infused) into an aqueous liquid stream directed through absorption loop 206.

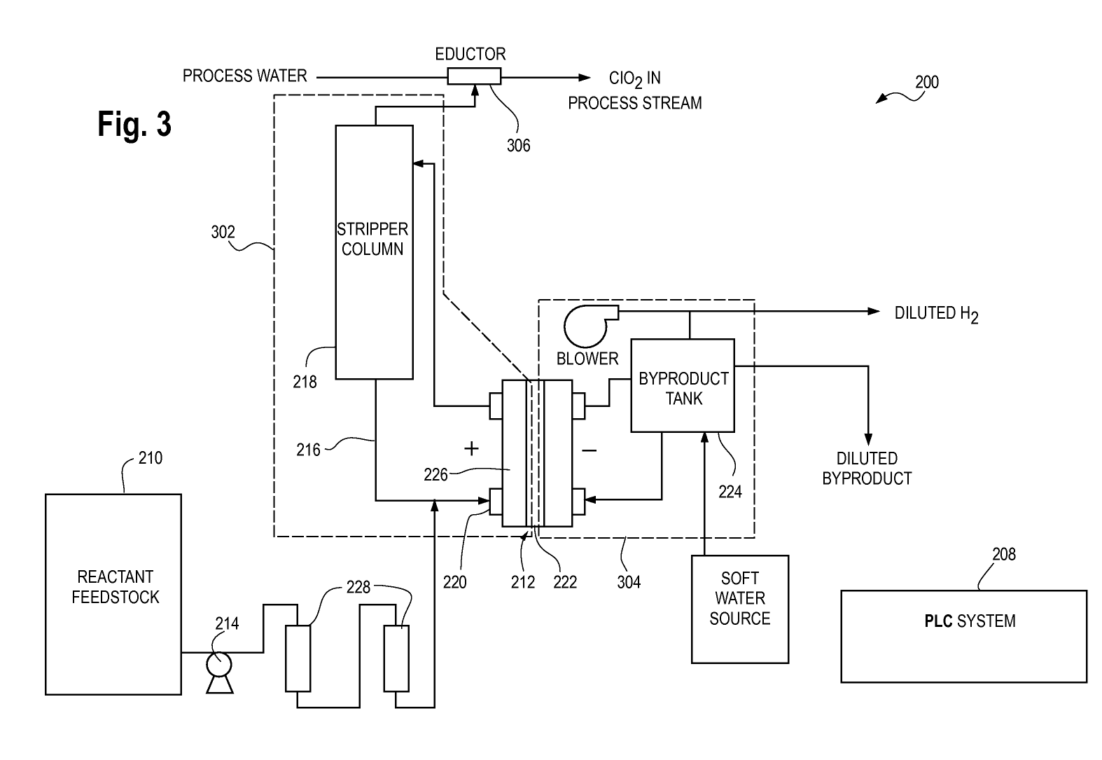

The ClO₂ gas can also be transferred to other water treatment end-uses without additional processing in an absorption loop. For example, FIG. 3 illustrates a process flow diagram of an electrochemical ClO₂ generator with hardness control of the reactant feedstock comprising an anolyte loop 302, a catholyte loop 304 and an eductor 306 wherein the ClO₂ gas is directly fed into a process water. In this application, the term “eductor” refers to a hydraulic device used to create a negative pressure (that is, suction) by forcing a liquid through a restriction, such as a Venturi. The various processes described can be operated at least partially through a PLC-based system 208 that can include visual and/or audible displays.

The contribution of anolyte loop 202, 302 to the ClO₂ solution generator is to produce a ClO₂ gas that can be directed to absorption loop 206 for further processing or to other water treatment end uses, as illustrated, for example, in FIGS. 2 and 3. The anolyte loop 202, 302 embodiment of FIGS. 2 and 3 is for a ClO₂ gas produced using a reactant feedstock 210. In a preferred embodiment, a 25 percent by weight sodium chlorite (NaClO₂) solution can be used as reactant feedstock 210. Feedstock concentrations ranging from 0 percent to a maximum solubility (40 percent at 17° C. in the embodiment involving NaClO₂), or other suitable method of injecting suitable electrolytes, can also be employed. The reactant feedstock 210 in FIGS. 2 and 3 is also known as the anolyte or anode solution for the electrochemical cell 212.

The reactant feedstock 210 can be connected to a chemical metering pump 214, which can deliver the reactant feedstock 210 to a recirculating connection 216 in the anolyte loop. Recirculating connection 216 in anolyte loop connects a stripper column 218 to an electrochemical cell 212. The delivery of the reactant feedstock 212 can be controlled using PLC system 208. PLC system 208 can be used to activate chemical metering pump 214 according to signals received from a pH sensor. The pH sensor is generally located along recirculating connection 216. A pH set point can be established in PLC system 208, and once the set point is reached, the delivery of reactant feedstock 210 can either start or stop.

Reactant feedstock 210 can be delivered to a positive end 220 (that is, the anode) of electrochemical cell 212 where the reactant feedstock is oxidized to form a ClO₂ gas, which is dissolved in an electrolyte solution along with other side products. The ClO₂ solution with the side products is directed away from electrochemical cell 212 to the top of stripper column 218 where a pure ClO₂ is stripped off in a gaseous form from the other side products. Side products or byproducts can include chlorine, chlorates, chlorites and/or oxygen. The pure ClO₂ gas can then be removed from stripper column 218 under a vacuum induced by gas transfer pump, or analogous gas or fluid transfer device (such as, for example, a vacuum-based device), where it is delivered to an absorption loop 206, as illustrated in FIG. 2. The remaining solution is collected at the base of stripper column 218 and recirculated back across the pH sensor where additional reactant feedstock 210 can be added. The process with the reactant feedstock and/or recirculation solution being delivered into positive end 220 of electrochemical cell 212 is then repeated.

The pure ClO₂ gas can also be removed from stripper column 218 where it is directed to an eductor 306 that combines the stripped ClO₂ gas with a process water desired for ClO₂ treatment, as illustrated in FIG. 3. The remaining fluid can be collected at the base of stripper column 218 and recirculated back across the pH sensor where additional reactant feedstock 210 can be added. The process with the reactant feedstock and/or recirculation solution being delivered into positive end 220 of electrochemical cell 212 can then be repeated.

As described in the '681 application, modifications to the anolyte loop process can be made that achieve similar results. As an example, an anolyte hold tank can be used in place of a stripper column. In such a case, an inert gas or air can be blown over the surface or through the solution to separate the ClO₂ gas from the anolyte. As another example, chlorate can be reduced to produce ClO₂ in a cathode loop instead of chlorite. The ClO₂ gas would then similarly be transferred to the absorption loop or eductor. In a further example, ClO₂ can be generated by chemical generators and transferred to an absorption loop for further processing or to an eductor.

Catholyte loop 204 contributes to the chlorine dioxide generator 200 by handling byproducts produced from the electrochemical reaction of reactant feedstock 210 solution in anolyte loop 202, 302. As an example, where a NaClO₂ solution is used as reactant feedstock 210, sodium ions from the anolyte loop 202, 302 migrate to catholyte loop 204, 304 through a cationic membrane 222 in electrochemical cell 212 to maintain charge neutrality. Water in the catholyte is reduced to produce hydroxide (OH⁻) and hydrogen (H₂) gas. The resulting byproducts in catholyte loop, in the example of a NaClO₂ reactant feedstock, are sodium hydroxide (NaOH) and H₂ gas. The byproducts can be directed to a byproduct tank 224.

In an embodiment of catholyte loop in the example of a NaClO₂ reactant feedstock, a soft (that is, demineralized) water source can be used to dilute the byproduct NaOH using a solenoid valve connected between soft water source and the byproduct tank 224. The solenoid valve can be controlled with PLC system 208. In a preferred embodiment, PLC system 208 can use a timing routine that maintains the NaOH concentration in a range of 5 percent to 20 percent. When byproduct tank 224 reaches a predetermined level above the base of byproduct tank 224, the diluted NaOH byproduct above that level is removed from catholyte loop.

In the example of a NaClO₂ reactant feedstock, the catholyte loop self-circulates using the lifting properties of the H₂ byproduct gas formed during the electrochemical process and forced water feed from soft water source. The H₂ gas rises up in byproduct tank 224 where there is a hydrogen disengager. The H₂ gas can be diluted with air in hydrogen disengager to a concentration of less than 0.5 percent. The diluted H₂ gas can be discharged from catholyte loop 204, 304 and chlorine dioxide generator 200 using a blower.

As described in the '681 application, in another embodiment, dilute sodium hydroxide can be fed instead of water to produce concentrated sodium hydroxide. Oxygen or air can also be used as a reductant instead of water to reduce overall operation voltage since oxygen reduces at lower voltage than water.

The reaction of anolyte loop 202, 302 and catholyte loop 204, 304 in the embodiments illustrated in FIGS. 2 and 3 using a NaClO₂ anolyte is represented by the following net chemical equation:

NaClO_{2(aq)}+H₂O→ClO_{2(gas)}+NaOH_{(aq)}+½H_{2(gas)}

The NaClO₂ is provided by reactant feedstock 202 of anolyte loop 202, 302. The NaOH and H₂ gas are byproducts of the reaction in catholyte loop 204, 304. The ClO₂ solution along with the starting unreacted NaClO₂ and other side products are directed to the stripper column for separating into ClO₂ gas as part of anolyte loop 202, 302 process. Chlorite salts other than NaClO₂ can be used in anolyte loop 202, 302.

Hardness control of the reactant feedstock 210 (that is, the anolyte) prior to entering the anode compartment is desirable to extend the operating life of the membrane 222 of the electrochemical cell 212. In an embodiment for a NaClO₂-anolyte based electrochemical chlorine dioxide generator, accelerated tests can be made to determine an acceptable concentration of Ca²⁺ for the operation of the generator. An acceptable concentration can be one in which the electrochemical generator functions for a one to three year operating time, that is, one to three years of cumulative actual operation of the electrochemical cell, without fouling the membrane. Therefore, if the electrochemical cell were to operate half of the time over a period of two to six years without fouling the membrane, that could qualify as an acceptable concentration of Ca²⁺. Another manner of determining an acceptable concentration uses the cell voltage; fewer impurities create a lower cell voltage. Theoretically, the Ca²⁺ concentration in the feed electrolyte is such that the ionic product of Ca²⁺ and OH⁻ is less than the solubility product constant at the operating temperature. At this theoretical Ca²⁺ concentration, calcium ions can generally pass through the membrane 222 without precipitating.

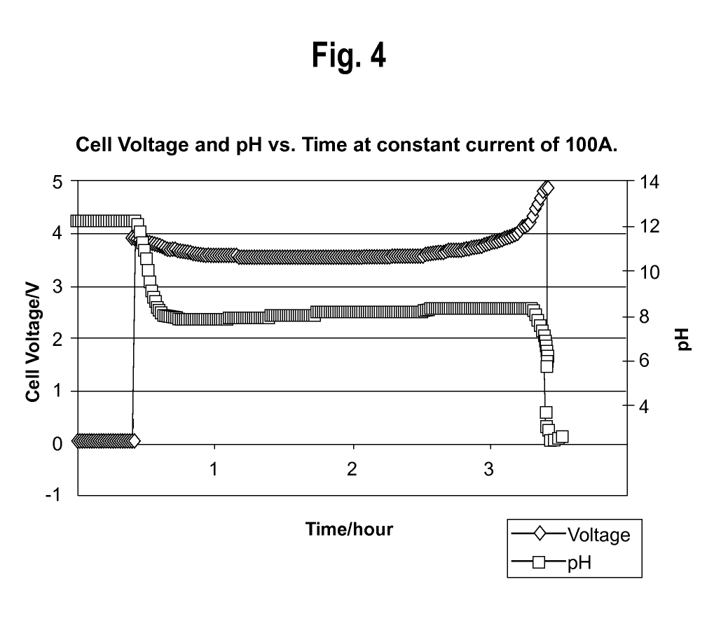

A method for assessing an acceptable concentration of Ca²⁺ in the actual operation of a chlorine dioxide generator is described. FIG. 4 is a graph showing voltage and pH as a function of electrolysis time of a 25% sodium chlorite electrolyte that was passed through an ion exchange column to remove hardness ions. The cell was held at a constant current of 100 ampere (A). This graph shows the cell voltage and the electrochemical cell operating time. The cell voltage can be defined as the minimum voltage shown on the graph. In FIG. 4 this value is approximately 3.4 volts (V). The electrochemical operating time, or time to degradation (TTD), can be defined as the end of the electrolysis reaction. On FIG. 4 the TTD is where the cell voltage approaches asymptotically 5V. This is shown on the graph where the cell voltage rises because there is no chlorite left. In FIG. 4, the TTD is approximately 3.3 hours. The pH decreases at this same time because the current is utilized in oxidizing water, which decreases the pH.

Chlorine dioxide electrochemical cells have their lowest cell voltage (as shown by the minimum voltage on an electrolysis time vs. voltage graph) for a given current density if there are no impurities in the electrolyte solution. As the impurity level increases, the cell voltage can correspondingly increase though the current density remains generally the same. The increasing impurities can cause the resistance along the membrane 222 to increase, which is the cause of the increased cell voltage. In a preferred embodiment, a membrane made of the Nafion® product is used.

In the example of a 25 percent sodium chlorite solution, if the calcium ion concentration is in the range of 1,000 ppm, cell voltage increases rapidly after only a few hours of cell operation. An anolyte with a known concentration of the target impurity, for example Ca²⁺, can be fed into the anode compartment 226 of an electrochemical cell 212. A TTD can be determined for a given Ca²⁺ concentration by plotting cell voltage vs. electrochemical cell operating time and determining the time necessary to reach 5 V. The TTD determination can be repeated at varying known concentrations of Ca²⁺, for example, from 1,000 ppm to 10 ppm. A plot of TTD vs. Ca²⁺ concentration can then be made and used to estimate the acceptable levels of Ca²⁺. In the TTD example, the Ca²⁺ concentration value can be extrapolated using the desired operating time for replacement of the membrane as the TTD value, for example, one to three years. These methods for assessing the acceptable concentration of Ca²⁺ can be used for other ions that are anticipated to precipitate in the membrane 222, for example, Mg²⁺, Fe²⁺, Ni²⁺ and Al³⁺.

An electrolyte feed formulation can then be made after the levels of acceptable hardness-causing impurities is assessed. In the example of Ca²⁺ concentration in a 25 percent sodium chlorite solution, a concentration of Ca²⁺ of less than 1 part per million will allow an acceptable operating life for the membrane of the electrochemical cell. In a preferred embodiment, the Ca²⁺ concentration in the electrolyte solution is less than 50 ppb. In another preferred embodiment, the Ca²⁺ concentration in the electrolyte solution is less than 20 ppb.

A method of reducing the levels of hardness-causing impurities from a sodium chlorite electrolyte solution is described. The method is described for removal of Ca²⁺ impurities, but it would be understood that the described method can be used to remove other multivalent ion impurities. A preferred method is the ion exchange resins method. Sodium chlorite salt is typically supplied as 80 percent solid with the remaining 20 percent of the salt comprising primarily water and secondarily other impurities such as hardness-causing impurities. The sodium chlorite salt is first dissolved in water. The majority of the divalent and trivalent ions can be removed through one or more passes of the solution through an ion exchange column. Examples of commercially available ion exchange resins that may be used include Amberlite™ IRC747, Lewatit TP207, and Duolite™ C467 resins. Ion exchange membranes can also be used. The amount of resin and the flow rate that reduces the level of impurity to an acceptable level, as determined by the methods described previously, can then be utilized.

The impurities in the electrolyte solution can also be lowered by passing the electrolyte solution, that is, the reactant feedstock 210, through the ion exchange column 228. In a further embodiment, one or more ion exchange columns 228 can be installed in line with the feed before entering the electrochemical cell 212.

Table 2 illustrates the reduction of calcium ion concentrations by treating a reactant feedstock with Amberlite™ IRC 747 ion exchange.

TABLE 2
Effect of Treating a Commercial-Grade 31% NaClO₂ Solution with
Amberlite ™ IRC 747 ion exchange resin.

| | Weight of | | |
|---|---|---|---|
| Volume of | ion-exchange | Duration of | Concentration |
| electrolyte | resin | treatment | of calcium ion |
| (milliliters) | (grams) | (minutes) | (ppm) |
| 60 | 0 | 0 | 36 |
| 60 | 1 | 15 | 8 |
| 60 | 1 | 60 | 3 |
| 60 | 2 | 15 | 4 |
| 60 | 4 | 15 | 1 |

The example of Table 2 illustrates that the amount ion exchange resin and duration of treatment of the NaClO₂ solution can affect the calcium ion concentration. Varying the amount of ion-exchange resin and treatment duration can reduce the level of calcium ion to a desired level. It would be understood that other hardness-causing ions can be removed by similar methods. It would be further understood that different commercially available ion-exchange resins can be used.

Another preferred embodiment for removing multivalent impurities from an electrolyte solution, such as the reactant feedstock 210, is the precipitation method. The precipitation method is described for removal of Ca²⁺ impurities for a solution containing calcium ions, but it would be understood that the described method can be used to remove other multivalent ion impurities, such as Mg²⁺, Fe²⁺, Ni²⁺ and Al³⁺. In the example of calcium ion impurities, calcium phosphate can be precipitated by adding a common ion such as phosphate to the electrolyte solution with Ca²⁺ impurities. The addition of the phosphate will lead to the precipitation of the calcium phosphate, which results in the removal of hardness-causing calcium ions from the reactant feedstock. In this example, an alkaline phosphate, such as sodium phosphate, sodium mono hydrogen phosphate, sodium dihydrogen phosphate or other soluble phosphates, can be used to effect the precipitation. Sodium can, for instance, be substituted by potassium or ammonium. The method can also be effective for other anions that have low solubility product constants with the impurity cations whose concentrations are desired to be reduced. The resulting precipitate from the precipitation method can be separated from the electrolyte solution using filtration. A centrifuge can also be used to separate the precipitate.

Table 3 illustrates decreasing calcium ion concentrations for various additives using the precipitation method.

TABLE 3
Effect of Adding Phosphate Salt Additives to a Commercial-Grade
31% NaClO₂ Solution on the Reduction of Ca²⁺ Concentrations

| Volume of | | Weight of | Concentration |
|---|---|---|---|
| electrolyte | | additive | of calcium ion |
| (milliliters) | Additive | (grams) | (ppm) |
| 60 | No additive | 0 | 36 |
| 60 | Na₃PO₄•12 H₂O | 1 | 22 |
| 60 | Na₂HPO₄ | 1 | 16 |
| 60 | Na₂HPO₄ | 2 | <1 |

It will be understood that various soluble salts can be used to effect the precipitation of a target impurity. The desired salt will be generally soluble in water, but will react and be effectively insoluble when the salt is combined with the target impurity in the feed electrolyte (that is, the reactant feedstock 210).

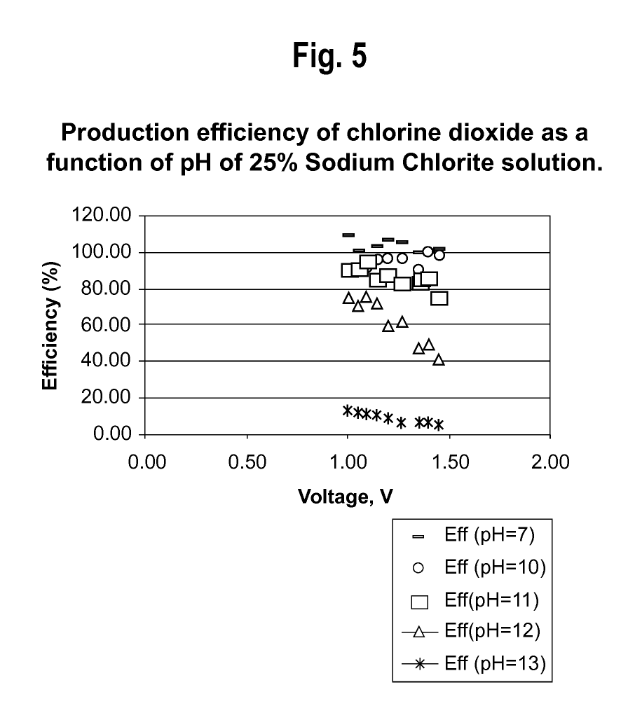

The above treatments produce electrolytes that increase electrochemical cell efficiency because they are lower in hardness ions. Efficiency of the electrochemical cell can be further increased by maintaining the pH of the electrolyte less than about 10. The pH of an electrolyte has an effect on the efficiency of chlorine dioxide production as shown by FIG. 5. FIG. 5 is a graph showing the efficiency (%) of chlorine dioxide production at various pH levels of a 25% sodium chlorite solution. As the graph shows, chlorine dioxide production efficiency decreases at pH levels greater than about 10. At a pH higher than about 10 the anolyte and catholyte react according to the reaction below.

2NaOH+2ClO₂→NaClO₂+NaClO₃

### When this side reaction occurs, chlorine dioxide yield is lowered and efficiency of 100% cannot be attained.

Because of the effect of pH on efficiency, it is advantageous to use electrolytes with a pH of less than about 10. Since they electrolytes produced by ion-exchange resins typically have pH levels greater than about 10, an additional treatment of the electrolyte can be added. After removing hardness ions using the ion exchange resin, dilute acid, such as sulfuric acid, can be added to lower pH to less than about 10. A gaseous carbon dioxide can also be bubbled through the electrolyte to reduce pH. Another method of reducing pH of the electrolyte would be to pass the hardness removed electrolyte through an acid ion exchange column. Yet another method is to remove hardness by adding sodium hydrogen phosphate. While phosphate removes hardness ions, the protons in the sodium hydrogen phosphate partially neutralize the hydroxide present in commercial electrolytes. This lowers the pH of the electrolyte to the desired level.

As mentioned above, migration of hydroxide into the anolyte compartment, also known as caustic migration, lowers chlorine dioxide yield because of the byproduct reaction between chlorine dioxide and sodium hydroxide discussed above. In order to increase efficiency of the electrochemical cell, it is desirable to decrease migration of hydroxide into the anolyte compartment. Another method of decreasing migration of hydroxide across the membrane is to attach a polymeric membrane with carboxylic groups to the cathode side of the membrane. Commercially available examples of such composite membranes include Dupont's N-series membranes such as N961, N962 and N966. A coated cathode side of the membrane can be used in conjunction with the electrolytes discussed above to further increase efficiency.

Efficiency of chlorine dioxide production can further be increased by variances in the anode material. Platinum anodes offer increased efficiency when used with electrolyte that is treated according to the methods above. Another possible electrode could be made of noble metal oxides, such as iridium, ruthenium oxide, and palladium oxide. Other mixed oxide metal oxides like iridium and tantalum oxide can also be used. The effect of using a platinum electrode is shown in the example below.

In one example, a 28 inch ion exchange column is prepared by loosely loading about 108 grams of Lewatit TP-207. The electrolyte is passed through the column at a flow rate of about 40 bed volumes per hour. The resulting electrolyte has less than 20 ppb calcium ions and less than 20 ppb magnesium ions.

In another example, about 166 grams of disodium phosphate is added to 5 kilograms of electrolyte and stirred. The solution is then decanted before using in a cell. The calcium level was about 50 ppb and the magnesium level was less than about 20 ppb.

3 to 4 kilograms of electrolyte prepared according to either of the methods described above is then loaded into the reservoir of a generator similar to that shown in FIG. 2. The efficiency of the cell can then be determined.

TABLE 4
Effect of Anode Material on Cell Efficiency Using Various Soft
Electrolytes

| | Concentration | Concentration | | |
|---|---|---|---|---|
| Method of | of calcium ions | of Magnesium | Anode | |
| Preparation | (ppb) | ions (ppb) | material | Efficiency |
| Ion exchange | Less than 20 | Less than 20 | Platinum | 98% |
| column | ppb | ppb | | |
| Ion exchange | Less than 20 | Less than 20 | Iridium and | 90% |
| column | ppb | ppb | Tantalum | |
| Disodium | Less than 50 | Less than 20 | Platinum | 96% |
| hydrogen | ppb | ppb | | |
| phosphate | | | | |

### As shown in Table 4 the platinum anode increases efficiency of the cell when used with the soft electrolytes.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A feed solution for an electrochemical generator, the feed solution comprising at least one of a chlorite solution and a chlorate solution, wherein hardness-causing ion concentration in at least one of the chlorite solution and the chlorate solution is reduced to less than 1 part per million using at least one of an ion exchange method and a precipitation method.

2. The feed solution of claim 1, wherein the hardness-causing ion concentration in the chlorite solution is reduced to less than 50 parts per billion.

3. The feed solution of claim 1, wherein the hardness-causing ion concentration in the chlorite solution is reduced to less than 20 parts per billion.

4. An electrochemical chlorine dioxide generator comprising:
(a) an anolyte loop, the anolyte loop comprising a reactant feedstock fluidly connected to an electrochemical cell; and
(b) a catholyte loop, the catholyte loop fluidly connected to the electrochemical cell;
wherein the reactant feedstock is an electrolyte solution passed through an ion exchange column, the ion exchange column capable of substantially removing hardness-causing ions in the electrolyte solution.

5. The electrochemical chlorine dioxide generator of claim 4, wherein at least one of the hardness-causing ions is a calcium ion, the calcium ion concentration is reduced in the electrolyte solution to less than 1 part per million.

6. The electrochemical chlorine dioxide generator of claim 4, wherein at least one of the hardness-causing ions is a calcium ion, the calcium ion concentration is reduced in the electrolyte solution to less than 50 parts per billion.

7. The electrochemical chlorine dioxide generator of claim 4, wherein at least one of the hardness-causing ions is a calcium ion, the calcium ion concentration is reduced in the electrolyte solution to less than 20 parts per billion.

8. The electrochemical chlorine dioxide generator of claim 4, further comprising an eductor, wherein the eductor is fluidly connected to the anolyte loop and the eductor combines chlorine dioxide gas from the anolyte loop with a process water.

9. The electrochemical chlorine dioxide generator of claim 4, further comprising an absorption loop wherein the absorption loop is fluidly connected to the anolyte loop and the absorption loop processes chlorine dioxide gas from the anolyte loop into a chlorine dioxide solution.

10. The electrochemical chlorine dioxide generator of claim 4, further comprising an anode.

11. The electrochemical chlorine dioxide generator of claim 10 wherein the anode is platinum operating at various currents

12. The electrochemical chlorine dioxide generator of claim 11 wherein the anode is a noble metal oxide.

13. The electrochemical chlorine dioxide generator of claim 4, further comprising an ion exchange membrane having an anode side and a cathode side where the cathode side is coated with a polymeric coating.

14. The electrochemical chlorine dioxide generator of claim 13, where the polymeric coating contains anionic groups.

15. The electrochemical cell of claim 14 wherein the anionic groups include carboxylate groups.

16. A method for assessing acceptable concentrations of hardness-causing impurities in an electrolyte solution, the method comprising the steps of:
(a) feeding an electrolyte solution with a known concentration of a target impurity into an anode compartment of an electrochemical chlorine dioxide generator;
(b) operating the electrochemical chlorine dioxide generator with the electrolyte solution until a time to degradation is reached for a membrane of an electrochemical cell in the electrochemical chlorine dioxide generator;
(c) repeating steps (a) and (b) at least once at a different known impurity concentration;
(d) creating a plot of the time to degradation vs. impurity concentration; and
(e) extrapolating the plot for a desired time to degradation to determine an acceptable concentration of the target impurity.

17. A method for reducing impurities in a sodium chlorite reactant feedstock, the method comprising the steps of:
(a) dissolving a sodium chlorite salt into an aqueous solution;
(b) passing the aqueous solution with dissolved sodium chlorite salt through at least one ion exchange column; and
(c) feeding the aqueous solution into the anode compartment of an electrochemical cell of a chlorine dioxide generator.

18. The method of claim 17 further comprising adding an acid to adjust the pH to less than 10.

19. The method of claim 17 further comprising bubbling gaseous carbon dioxide through the reactant feedstock.

20. A method for reducing calcium impurities in a reactant feedstock, the method comprising the steps of:
(a) dissolving alkaline phosphate into the reactant feedstock solution containing calcium ions, wherein phosphate from the alkaline phosphate will react with the calcium to form calcium phosphate;
(b) filtering the resulting calcium phosphate from the reactant feedstock solution; and
(c) feeding the filtered reactant feedstock into the anode compartment of an electrochemical cell of a chlorine dioxide generator.

21. The method of claim 20 wherein the alkaline phosphate is sodium hydrogen phosphate.

22. The method of claim 20 further comprising bubbling gaseous carbon dioxide through the reactant feedstock.
